(19) United States
(12) Patent Application Publication
(10) Pub. No.: US 2025/0117436 A1
(43) Pub. Date: Apr. 10, 2025

(54) Pet Care Online Booking System

(71) Applicant: Seyed M. Motahari, Atlanta, GA (US)

(72) Inventor: Seyed M. Motahari, Atlanta, GA (US)

(21) Appl. No.: 18/482,861

(22) Filed: Oct. 7, 2023

(51) Int. Cl. G06F 16/954; G06Q 10/1093

(52) U.S. Cl. CPC G06F 16/954; G06Q 10/1095

(57) ABSTRACT

Our innovative features are:
Personalized pet profiles
Ai-driven matching algorithms for services
Seamless scheduling tools
Integrated health tracking
Robust health monitoring.
Easy communication tools.
Tailored care for beloved pets.

Title of the Invention: “A user-friendly online booking method (website and mobile application) for nationwide pet care, grooming services, pets' hotel and veterinary appointments”. Evidently, there is no other platform that offers these services all at once. Therefore, we hereby request The US Patent and Trademark Office to review and approve this claim as an invention.

### 2. BACKGROUND

Pet owners are always in need of pet hotels, grooming services and vet appointments. There is no other platform to connect pet owners to these providers as of right now. For instance, a pet owner who is travelling may need their pets to be kept in a pet's hotel for a night. This will be the easiest way to search available providers nearby

### 3. SUMMARY OF THE INVENTION

### 3-1. User-Friendly Mobile App and Website:

Developing a user-friendly and easy to use app and website accessible on both mobile and desktop platforms for pet owners to book their pets appointment.

### 3-2. User Profiles:

Allow pet owners to create profiles for their pets, including details like breed, age, and medical history.

Enable service providers to create professional profiles with information about their experience and services.

### 3-3. Booking and Scheduling:

Implement a booking calendar where pet owners can schedule appointments with service providers.

Offer flexible scheduling options, including one-time or recurring appointments, last minute bookings, or notified if there's a cancellation from another pet owner.

### 3-4. Real-Time Availability:

Our platform will show the real-time availability of service providers, allowing pet owners to choose convenient time slots.

### 3-5. Search and Filters:

Enable users to search for specific services, such as dog walking, grooming, or pet sitting, and filter results by location, price, and ratings.

### 3-6. Secure Payment Processing:

Integrating a secure payment gateway for seamless transactions.

Easy pay options such as in-app payments or subscription plans for frequent users.

### 3-7. Reviews and Ratings:

Implementing a review and rating system for service providers.

Allowing users to leave feedback and share their experiences.

### 3-8. Notifications and Reminders:

Sending automated appointment reminders to both pet owners and service providers.

Notify users about booking confirmations, cancellations, or important updates.

### 3-9. Service Tracking:

Allowing pet owners to monitor their pet's process and well-being in real time, notified when their pet is ready for pick up.

### 3-10. Emergency Contacts:

Providing a feature for users to add emergency contacts and veterinary information for their pets.

### 3-11. In-App Messaging:

Enabling secure messaging between pet owners and service providers to discuss details or special requirements.

### 3-12. Insurance and Liability Coverage:

Offering options for service providers to showcase their insurance coverage and certifications through third parties.

### 3-13. Promotions and Discounts:

Implement a system for running promotions, discounts, or referral programs to attract and retain users.

### 3-14. Customer Support:

Provide responsive customer support channels for users to seek assistance or resolve issues.

### 3-15. Analytics and Reporting:

Include analytics tools to help service providers track their earnings, appointments, and customer reviews.

### 3-16. Privacy and Security:

Prioritizing data privacy and security, ensuring that user and pet information is safeguarded.

### 3-17. Feedback and Improvement:

Regularly gathering user feedback and use it to make improvements to the system.

### 3-18. Legal:

ChetoPet.com and Pet Care Solutions Inc collectively have no legal liabilities/obligations toward pet owners and/or service providers. We basically act as a middle party to connect them together. Providers must use their own insurance in case of liabilities, and pet owners assume no responsibility from us when it comes to disputes.

### 3-19. Geolocation Services:

Utilizing geolocation to connect pet owners with nearby service providers for added convenience.

### 3-20. Multi-Platform Integration:

Consider integrating your booking system with other pet-related platforms, such as pet supply stores or veterinary clinics.

### 4. BACKGROUND

As a previous pet owner, I always had to look for providers, call multiple places to get a basic grooming appointment, for instance. I am dedicated to ChetoPet.com and eager to make this process easy for pet owners as well as service providers.

### 5. UNIQUE FEATURES AND ADVANTAGES

Online based. Easy to navigate/book.

### 6. PATENT CLAIMS

There is no provider, third party, or website that offers all these online booking services.

### 7. DETAILED IMPLEMENTATION

We are going to sign up as many service providers as possible, so pets' owners can find open and available providers at any time during the day.

### 8. MARKET POTENTIAL

-Each vet examines an average of 40 pets a day. Each groomer facility takes care of 6-8 pets a day. Each pet hotel shelters about 25-30 pets every 24 hours. There is an incredible need for ChetoPet.com to connect all these pet owners to providers with an easy click on the app and see their availabilities.

### 9. INTELLECTUAL PROPERTY STRATEGY

We would like to patent this idea, as it is very unique and nonexistent.

### 10. CONCLUSION

This service will bring ease and peace of mind to pet owners when they need their pets taken care of, and revenue to local pet care service providers.

1. This method stands out as a unique innovation in the pet care industry due to its combination of features and functionalities that have not been integrated into a single platform before. While individual websites or apps may offer booking services for specific pet care needs such as grooming or veterinary appointments, none provide a comprehensive solution that encompasses scheduling for grooming services, veterinary appointments, and doggy daycare (hotel) accommodations within a unified interface. Furthermore, the integration with calendar systems of pet care providers in real-time, alongside personalized recommendations based on pet health records and user preferences, sets this method apart from existing solutions. The seamless user experience and enhanced functionality of this platform address a significant gap in the market, offering pet owners unparalleled convenience and efficiency in managing their pets' care needs.
Claim explained in detail:
A method for facilitating pet care services comprising providing a comprehensive and user-friendly website interface accessible to pet owners, featuring intuitive navigation and interactive elements; wherein the website/application interface seamlessly integrates scheduling functionalities for grooming services, veterinary appointments, and doggy daycare accommodations within a unified platform, streamlining the booking process for pet owners and enhancing efficiency for pet care providers.
The method further includes the implementation of sophisticated backend systems, which enable seamless integration with the calendar systems of participating pet care providers. This integration allows for real-time synchronization of appointment availability, ensuring accurate scheduling and minimizing scheduling conflicts.
Moreover, the website incorporates advanced algorithms to analyze and leverage pet health records and user preferences provided by the pet owner. By utilizing this data, the platform generates personalized recommendations for pet care services, including tailored grooming treatments, suitable veterinary specialists, and optimal doggy daycare arrangements. These personalized recommendations enhance the user experience, foster trust and loyalty among pet owners, and contribute to the overall well-being and happiness of pets.
Additionally, the method involves robust security measures to safeguard sensitive user information and uphold privacy standards, thereby instilling confidence in pet owners regarding the protection of their data.
In summary, the method provides a comprehensive solution for pet owners seeking convenient and efficient access to a wide range of pet care services, while also offering pet care providers an effective platform to manage their appointments and engage with pet owners in a personalized manner.
